(19) United States
(12) Patent Application Publication
(10) Pub. No.: US 2009/0277096 A1
(43) Pub. Date: Nov. 12, 2009

(54) SEALING GASKET FOR REFRIGERATOR DOOR AND SEALING SYSTEM

(75) Inventors: Ubirajara Aracauna Pereira Ramos, Joinville (BR); Axel Julio Ramm, Joinville SC (BR); Joel Ribeiro, Joinville - Sc (BR); Thiago Deotti Carvalho, Joinville SC (BR); Vinicius Severo Leaes, Joinville (BR)

Correspondence Address: DARBY & DARBY P.C., P.O. BOX 770, Church Street Station, New York, NY, 10008-0770, US

(73) Assignee: WHIRLPOOL S.A., Sao Paulo - SP (BR)

(21) Appl. No.: 12/426,437

(22) Filed: Apr. 20, 2009

(30) Foreign Application Priority Data
Apr. 18, 2008 (BR) PI0801138-9
Mar. 20, 2009 (BR) PI0901049-1

(51) Int. Cl. E06B 7/22; E06B 7/16

(52) U.S. Cl. 49/478.1; 49/499.1

(57) ABSTRACT

The present invention relates to a sealing system for refrigerator door and, more specifically, to a sealing system of the kind that comprises a gasket to be inserted in a receiving channel (60) disposed in the refrigerator door. The sealing gasket of the present invention comprises an attachment part (40) joined to the sealing bag (50), the attachment part (40) comprising an end portion (41) having a substantially triangular profile and a body portion (42) having a W-shaped cross section with bulged walls (45, 46). The end portion (41) is formed by two flaps (43, 44) symmetrically opposed, each of the flaps (43, 44) forming an angle with each of the bulged walls.

### FIELD OF THE INVENTION

The present invention relates to a sealing system for refrigerator door and, more specifically, to a sealing system of the kind that comprises a gasket to be inserted in a receiving channel disposed in the refrigerator door.

### BACKGROUND OF THE INVENTION

Sealing the door of the refrigerated compartment of a refrigerator or freezer is essential to grant proper and efficient refrigeration. The inlet of hot air in the generated refrigerated compartment and the outlet of cool air from the same impact the efficiency in preserving the refrigeration, the energy consumption (excessive activation of the compressor), and may still cause water formation in the inside and outside of the compartment due to condensation or unwanted ice formation.

The gasket also has the important function of absorbing variations caused by the dimensions of the refrigerator door and cabinet and consequently of the gap door-cabinet. In fact, the gasket it must be flexible enough to accommodate (or absorb) these variations of dimension, but it must be robust enough not to excessively distress due to traction forces

The most commonly used way to carry out the sealing of the refrigerator door is by means of a magnetic gasket. This gasket generally comprises an attachment part and a sealing bag housing a magnet. The attachment part is received in a receiving channel disposed in a peripheral inner portion of the refrigerator door, and the magnet is housed in the sealing bag which contacts a metallic flange of the body of the refrigerator in order to assure the proper sealing of the door.

Although gaskets with these general characteristics are known, the project and construction characteristics of this type of gasket still represent a great technical challenge, since the properties achieved by a specific gasket project directly influence its sealing ability and service life.

Therefore, three main gasket properties may be noted: its traction resistance, its compression resistance and its torsion resistance.

When the refrigerator door is offset, for example, during the closing or opening of the door, the gasket, which is generally made of polymeric material, is “stretched” (opening) and “compressed” (closing). Thus, the degree of distress of the gasket during these operations directly impacts upon its sealing ability and service life.

In addition, since the sealing bag houses a magnet, it is important that the sealing bag supports the weight of this magnet, assuring the same will contact the flange of the refrigerator in the right position. Thus, it is desirable that the assembly bears little torsion during the door displacement.

### PRIOR ART DESCRIPTION

Considering the desired properties for the gasket, a number of different constructions and geometries were proposed for a sealing gasket. These constructions are known, for example, from documents PI9913633-3, U.S. Pat. No. 6,227,634, U.S. Pat. No. 6,526,698, US 2004/0244297, US 2006/0188690 and PI0503971-1.

Document PI 9913633-3 describes a gasket whose attachment portion comprises at least three retention cams, one of the cams presenting, in relation to vertical, an intermediary angle blunter than the two other cams.

Document U.S. Pat. No. 6,227,634 describes a gasket developed to better resist to the compression and traction forces acting over it when the door is being moved. The solution proposed in this document consists of using two different materials for producing part of the sealing bag.

Document U.S. Pat. No. 6,526,698 describes a sealing system for refrigerator door, wherein the receiving channel of the attachment portion of the gasket has an asymmetric profile, as to facilitate gasket assembling.

Document US 2004/0244297 describes profiles for the sealing bag of a gasket. According to this document, an additional flap in the bag is predicted which conducts magnetic tension force from the magnet region to the attachment part region of the gasket.

Document US 2006/0188690 describes a gasket constructed from a specific material, which would have better extrusion properties.

Eventually, document PI 0503971-1 describes a gasket having an attachment part with a curved profile and a sealing bag divided into a side sealing bag, an intermediate sealing bag, a main sealing bag, three secondary sealing bags, and a magnet compartment.

Although the listed documents represent efforts as to achieve a construction of an efficient sealing gasket with long-lasting service life, there is still the search for a solution that allies cost efficiency and manufacturing ease to a gasket with good properties of variation absorption and traction resistance, compression resistance and torsion resistance.

### OBJECTIVES OF THE INVENTION

Based on the afore-mentioned, it is one of the objectives of the present invention to provide a sealing system for a refrigerator door which provides an efficient sealing, but which maintains an acceptable manufacturing cost.

It is another objective of the present invention to provide a low cost sealing gasket with good properties of variation absorption and traction resistance, compression resistance and torsion resistance.

It is another objective of the present invention to provide a sealing gasket with a long service life, which presents little distress when subjected to the efforts of compression and traction.

### SUMMARY OF THE INVENTION

The present invention achieves the above objectives by means of a sealing gasket for refrigerator door comprising an attachment part joined to the sealing bag. The attachment part comprises an end portion having a substantially triangular profile and a body portion having a W-shaped cross section with bulged walls, the end portion being formed by two flaps, each of the flaps forming an angle with each of the bulged walls.

In a preferred embodiment of the present invention, the sealing bag comprises a base part for the attachment part, a pillar-shaped body part, and a contacting part which contacts at least part of a refrigerator cabinet. In this embodiment, the base part comprises a base wall extending substantially parallel to the refrigerator door, the pillar-shaped body part comprises two side walls and a reinforcement structure, and the contacting part comprises a magnet receiving part and an end portion.

In one embodiment of the invention, the reinforcement structure comprises a parallelogramal lattice structure, with one of the longest sides defined by part of the base wall and one of the shortest sides defined by part of the wall. In this embodiment, the second shortest side of the parallelogram starts in a supporting part of the base wall, being the supporting part concurrent to the part of the base wall which joined to one of the bulged walls of the body part of the attachment portion.

In the preferred embodiment of the present invention, the magnet receiving part is offset in relation to the end of the outer flange of the refrigerator cabinet, towards the outside of the cabinet.

The present invention further contemplates a sealing system comprising the sealing gasket of the present invention, and a receiving channel comprising: a triangular part defined by two side walls which are located in a vertex end, and an opening part which receives an attachment part of the gasket.

### BRIEF DESCRIPTION OF THE DRAWINGS

Figures show:

FIG. 1—FIG. 1 illustrates a sectional view of a sealing gasket known from the prior art.

FIG. 2—FIG. 2 illustrates the result of a simulation test representing the tension assessment resulting from the compression of a prior art gasket.

FIG. 3—FIG. 3 illustrates the result of a simulation test representing the distress suffered by a prior art gasket during its compression.

FIG. 4—FIG. 4 illustrates the result of a simulation test representing the distress suffered by a prior art gasket when subjected to traction forces

FIG. 5—FIG. 5 illustrates the result of a simulation test representing the distress suffered by a prior art gasket when subjected to torsion forces.

FIG. 6—FIG. 6 illustrates a sectional view of a first embodiment of the sealing gasket of the present invention.

FIG. 7—FIG. 7 illustrates a detailed sectional view of the attachment part of a first embodiment of the sealing gasket of the present invention.

FIG. 8—FIG. 8 illustrates a detailed sectional view of the attachment part and the receiving channel of a first embodiment of the sealing system of the present invention.

FIG. 9—FIG. 9 illustrates the result of a simulation test representing the tension assessment resulting from extracting the sealing gasket of the present invention.

FIG. 10—FIG. 10 illustrates the result of a simulation test representing the tension assessment resulting from inserting the sealing gasket of the present invention.

FIG. 11—FIG. 11 illustrates a sectional view of a first embodiment of the sealing gasket of the present invention.

FIG. 12—FIG. 12 illustrates a schematic view of the gasket of the present invention when contacting the flange of the refrigerator cabinet.

FIG. 13—FIG. 13 illustrates the result of a simulation test representing the tension assessment resulting from the compression of the first embodiment of the gasket of the present invention.

FIG. 14—FIG. 14 illustrates the result of a simulation test representing the distress suffered by the gasket of the present invention during its compression.

FIG. 15—FIG. 15 illustrates the result of a simulation test representing the distress suffered by the gasket of the present invention when subjected to traction forces

FIG. 16—FIG. 16 illustrates the result of a simulation test representing the distress suffered by the gasket of the present invention when subjected to torsion forces.

FIG. 17—FIG. 17 illustrates a sectional view of a second embodiment of the sealing gasket of the present invention.

FIG. 18—FIG. 18 illustrates a detailed sectional view of the attachment part and of the receiving channel of a second embodiment of the sealing system of the present invention.

### DETAILED DESCRIPTION OF THE INVENTION

The present invention will be described in fine detail, as follows, based on the execution examples represented in the drawings.

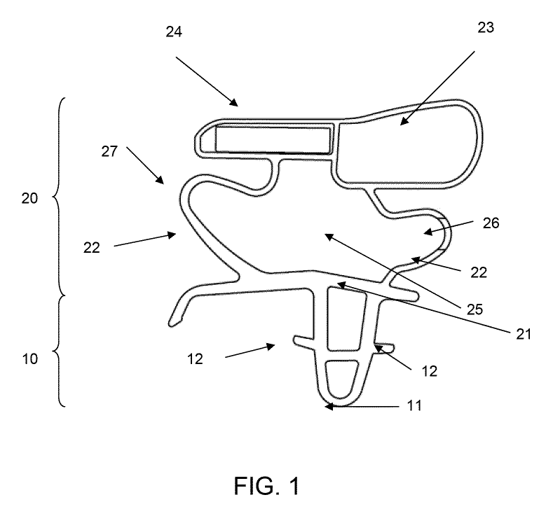

FIG. 1 shows a sealing gasket known in the art. The gasket 1 has an attachment portion 10 and a sealing bag 20.

The attachment portion 10 has a profile of arched end 11 and two cams 12 protruding from its side walls. Thus, when attaching the gasket to the door, the attachment portion 10 is inserted in a circular or square, symmetric or asymmetric receiving channel (see prior art documents, for example, document PI 9913633-3 or document PI0503971-1).

The sealing bag 20 of the prior art gasket is formed by a base part 21 for the attachment portion 10, two side walls 22, an end part 23 and a magnet receiving part 24. The side walls 22, and part of the walls of the end part 23 and the magnet receiving part 24 define a hollow space 25.

In the commonly used gasket, the attachment portion has a total length of approximately 9.4 mm (from the plane which grazes the end of the arch to the plane which grazes the base part 21), and the sealing bag has a total length of approximately 14.4 mm (of the plane which grazes the base part 21 to the plane which grazes the upper wall of the magnet receiving part 24).

The magnet receiving part 24 of the gasket known in the prior art generally has a rectangular profile, with approximately 11.5 mm of width and 3.2 mm of length, and the end part 23 has an asymmetric profile, the lower wall having approximately 11.5 mm of width and the upper wall bent starting 5.6 mm from the lower wall and ending 7.1 mm from the height of the lower wall (it must be noted, however, that the dimension of the end part 23 may vary according to the product). One of the side walls of the end part 23 is concurrent with the side wall of the magnet receiving part 24 and the other side wall is substantially arched.

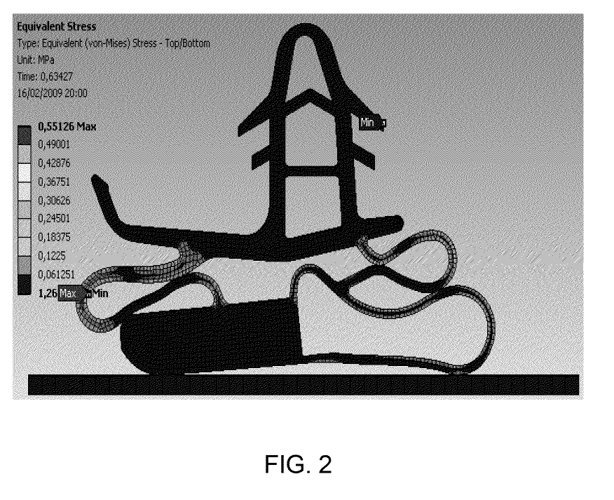

The side walls 22 have approximately 1 mm of thickness and form, each one, protruding flap 26, 27. The function of these flaps will be more clearly evident based on the description of FIGS. 2 to 5, which illustrate the behavior of a prior art gasket upon compression, traction and torsion forces.

The base part 21 of the attachment part 10 has a bipartite profile in the form of an inverted V, wherein the attachment portion is supported in one of the legs of the inverted V. The part of the base wall which supports the attachment portion has approximately 1 mm of thickness and the second leg has approximately 1.4 mm of thickness.

It must be noted that the dimensions of the gasket, as well as the construction details and measurements of the walls which form the sealing bag 20, have an important impact upon the efficiency of the gasket, since they influence in its behavior upon compression, traction and torsion forces that the gasket bears during the door displacement.

FIGS. 2 the 5 illustrate the behavior of a prior art gasket upon compression, traction and torsion forces. It must be noted that the prior art gasket illustrated in FIGS. 2 to 5 differs a little from the one illustrated in FIG. 1, the attachment portion of the gasket illustrated in FIGS. 2 to 5 presenting four cams.

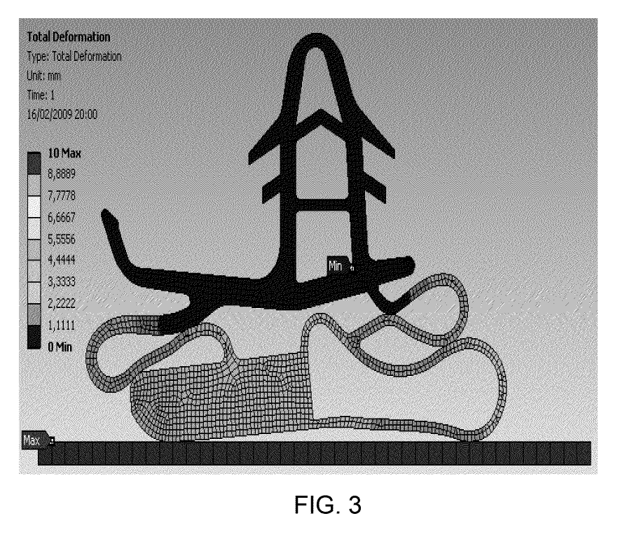

FIGS. 2 and 3 illustrate the behavior of the gasket when subjected to a compression force: FIG. 2 illustrates the forces acting over the gasket and FIG. 3 illustrates the distress of the gasket parts (in mm).

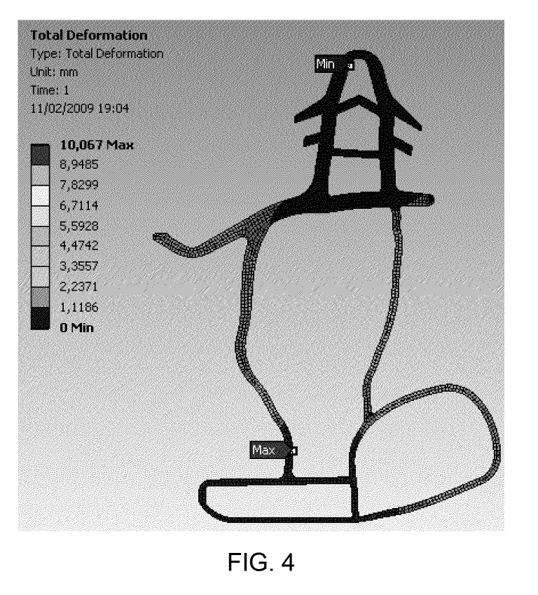

FIG. 4 illustrates the behavior of the gasket when subjected to a force of traction, showing the distress of the gasket parts (in mm).

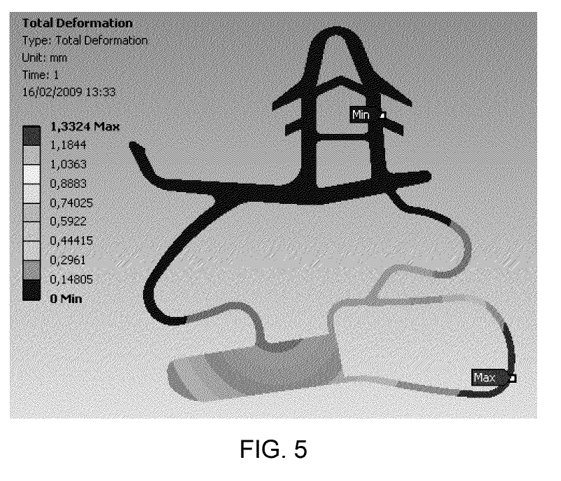

FIG. 5 illustrates the behavior of the gasket in relation to the torsion due to the magnetic inertia and magnet weight.

Although the prior art gaskets illustrated in FIGS. 1 to 5 are able to provide some resistance to compression, traction and torsion forces, the gasket of the present invention was developed as to provide even higher levels of resistance, being more resistant to distress and, thus, able to preserve its sealing ability more efficient and durable.

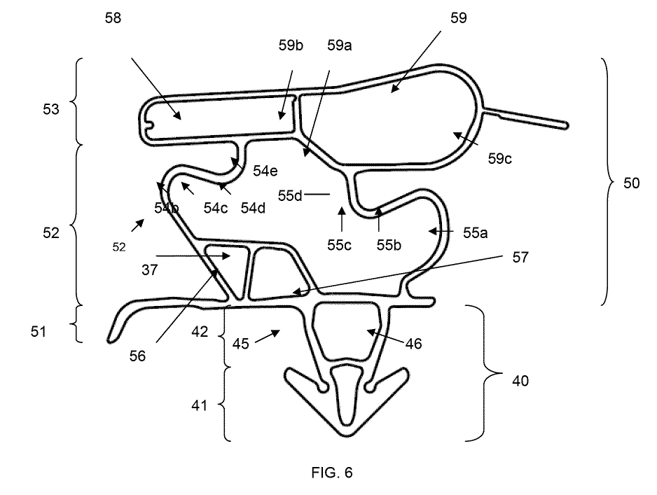

FIG. 6 illustrates a sectional view of a preferred embodiment of the sealing gasket of the present invention. The gasket 30 comprises an attachment part 40 and a sealing bag 50.

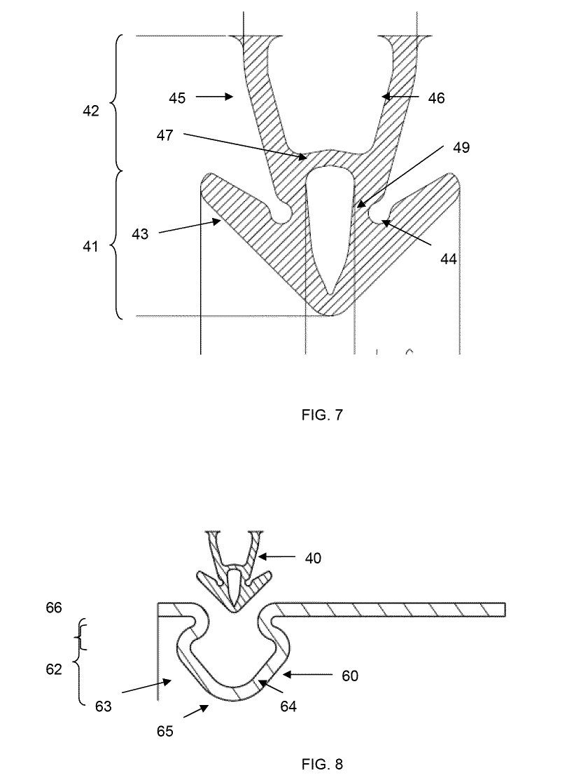

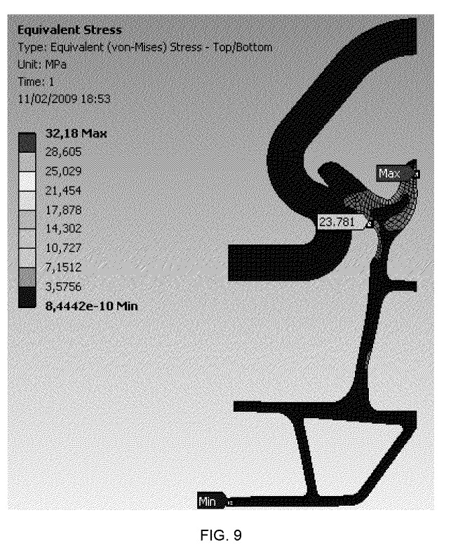

As better illustrated in FIG. 7, the attachment part 40 presents an end portion 41 with a substantially triangular profile and a body portion 42 whose cross section is W-shaped with bulged walls. As known by those skilled in the art, the attachment part 40 it is received by a receiving channel disposed in the inner periphery of the refrigerator door. FIG. 8 shows details of the insertion of the attachment part 40 in a receiving channel 60 of a refrigerator door (not illustrated).

The geometry of the attachment portion 40 and the receiving channel 60 of the present invention was developed as to provide a more efficient groove between the pieces, making the attachment easy, and achieving a greater retention force after attachment. Thus, the geometric solution proposed by the sealing system of the present invention provides a safer attachment of the sealing gasket to the door, allows the sealing to remain in place even after successive and constant door displacements.

The end portion 41 is formed by two symmetrically opposed flaps 43, 44 which define the triangular shape, forming two of the walls of an isosceles triangle.

As illustrated in FIGS. 6 the 8, the body portion 42 of the attachment part 40 has a substantially W-shaped cross section, but with bulged walls. Thus, the two side walls 45, 46 are bulged outward the attachment part, whereas the cross-sectional wall 47 is bulged inward of the W.

In the preferred embodiment of the gasket of the present invention, the total length of the attachment part (from the plane which grazes the vertex of the end portion 41 to the plane which grazes the end final of the bulged walls 45, 46) is of 9.1 mm, the greater width of the end part 41 (measured between the flap free ends 43 and 44) is of 8.4 mm, and the greater width of the body portion 42 (measured in the outermost region of the bulging of the walls 45, 46) is of 5.6 mm.

Still in the preferred embodiment, the distance between the flap free ends 43, 44 and the end of the walls 45, 46 is 4.15 mm.

Each flap 43, 44 forms an angle of approximately 41.9° with each side wall 45, 46. This angle, together with the length of the flaps, causes the extraction and insertion functions of the gasket in the receiving channel of the refrigerator door to present an enhanced behavior comparing to that of the gaskets known in the art

Therefore, there is a tension relief opening 49 in the joint of the flaps 43, 44 with the body part 42, which diameter, in a preferred embodiment is approximately 0.7 mm. This opening allows for a greater flexibility of the flaps 43 and 44, facilitating the function of gasket insertion.

In the preferred embodiment, each flap 43, 44 has approximately 4.9 mm of length and approximately 0.8 mm of thickness in its thinner portion.

It must be noted, however, that these dimensions may vary within the geometry proposed by the present solution, and a variation of approximately 10% in this dimension still allows achieving the advantages brought up by the proposed geometry.

The attachment part 40 further has an elongated drop-like opening 48, extending from the cross-sectional wall 47 to the vertex formed in the joint of the flaps 43, 44.

In a preferred embodiment, the elongated opening 48 has, in its broader portion, a thickness of approximately 1.6 mm.

Although the attachment part 40 has been defined as comprising distinct parts and walls, it must be understood that this part is preferably constructed in a continuous piece.

The geometry of the receiving channel 60 of the present invention also influences the advantageous insertion and retention characteristics achieved with the present invention.

Channel 60 has a form corresponding to the one of the attachment part 40, comprising a triangular part 62 defined by two side walls 63, 64 which are located in a vertex end 65, and an opening part 66. The walls 63, 64 meet the opening part 66 in a curved wall with a channel inner radius of 2.10 mm (this curved wall having a length of approximately 5.86 mm), and the wall forming the opening part 66 is joined to the rest of the body of the channel by a curved wall with a radius of 1 mm (this curved wall having a length of approximately 1.91 mm).

In the preferred embodiment of the present invention, the opening 66 of the channel has a length of 5.5 mm. It must be noted, however, that this dimension may vary within the geometry proposed by the present solution, and a variation of approximately 30% in this dimension still allows achieving the advantages brought up by the proposed geometry.

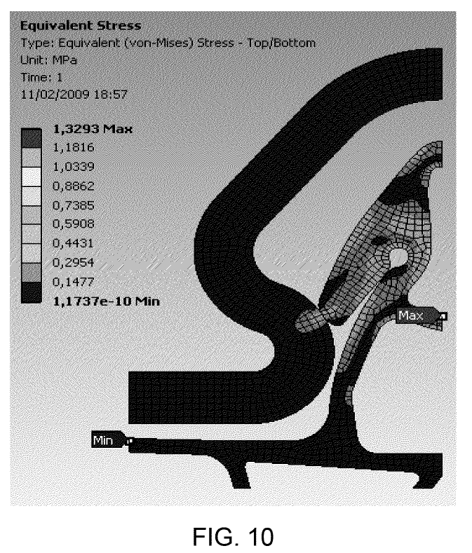

FIGS. 9 and 10 illustrate test results which attest the efficiency of the setting of the sealing system of the present invention. Thus, FIG. 9 shows the result of a simulation test representing the tension assessment resulting from extracting the sealing gasket of the present invention, and FIG. 10 shows the result of a simulation test representing the tension assessment resulting from inserting the sealing gasket of the present invention.

The gasket of the present invention further comprises a sealing bag 50. The sealing bag 50 comprises a base part 51 for the attachment part 40, a pillar-shaped body part 52, and a contacting part 53 which contacts the refrigerator cabinet when its door is closed.

The base part 51 comprises basically a base wall 51 which closes the “W” formed by the body portion 42 of the attachment part 40 and extends throughout the length of the body part 52 of the bag 50. In the preferred illustrated embodiment in FIGS. 6 to 14, the base wall 51 remains substantially parallel to the refrigerator door.

The body part 52 of the bag 50 comprises two side walls 54, 55. When in rest setting (in which the gasket does not bear compression and traction forces), one of the walls 54 comprises the form of a half arrow tip granted by a first part of the bent wall 54a which starts in the base wall 51 and extends until a first part of the curved wall 54b. At the first part of the curved wall 54b, follows a second part of bent upper wall 54c forming the base of the “half arrow” and ends in a second part of curved wall 54d extending until part of the curved end wall 54e extending substantially cross-sectional to the base wall 51 of the bag 50. The other wall (wall 55) comprises, in rest setting, a first part of curved wall 55a extending inward until part of the bent wall 55b ending in a second part of curved wall 55c extending until part of the end wall part 55d extending substantially cross-sectional to the base wall 51.

In the preferred embodiment of the present invention, the first part of the bent wall 54a has approximately 7.23 mm, the first part of curved wall 54b has approximately 3.95 mm, the second part of the bent wall 54c has approximately 2.02 mm, the second part of curved wall 54d has approximately 2.26 mm and the part end wall has approximately 0.47 mm. The first part of curved wall 55a has approximately 8.72 mm, the part of the bent wall 55b has approximately 2.94 mm, the second part of curved wall 55c has approximately 1.64 mm and the part of end wall part 55d has approximately 1.39 mm.

The parts of the end walls 54e and 55d extend to the walls which define the contacting portion 53.

The body part 52 of the bag 50 further comprises a reinforcement structure 56 adjacently to the base wall 51 and to one of the walls 54 of the body part 52. In the preferred embodiment illustrated in the figures, this reinforcement structure 56 comprises a lattice structure presenting a parallelogram-like form, with one of the longest sides defined by part of the base wall 51 and one of the shortest sides defined by part of the first part of the bent wall 54a of the wall 54. The second shortest side of the parallelogram starts in a supporting part 57 of the base wall 51. The supporting part 57 coincides with the base wall part 51 which is joined with one of the bulged walls 45 of the body part 42 of the attachment portion 40. In the preferred embodiment shown in the figures, the supporting part 57 has a reinforced thickness, in order to grant more resistance to this joint point. The other longest side of the parallelogram starts in the second shortest side and extends until the wall 54 (in a preferred embodiment, this side has approximately 6.56 mm). In order to provide a greater robustness to the reinforcement structure 56, it is further provided an intermediate wall 37, extending to a point of the base wall 51 next to the wall 54 until a medium point of the longest second side of the parallelogram.

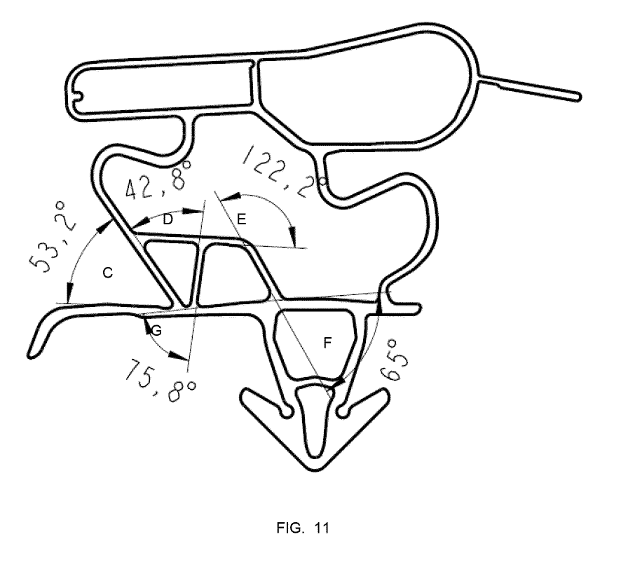

In the preferred embodiment, the sides of the parallelogram of the reinforcement structure form angles C to G illustrated in FIG. 11.

The contacting part 53 of the bag 50 comprises a magnet receiving portion 58 and an end portion 59. The magnet receiving portion 58 has a substantially rectangular form, having two largest parallel walls and two also parallel shortest walls. The end portion 59 is similar to an asymmetric tongue and comprises a first part of the bent wall 59a, a second part of cross-sectional wall 59b to the base wall 51 and a curved wall 59c, the curved wall protruding outwardly the body of the bag across the base wall 51.

In the gaskets known in the state of the art, the position of the magnet receiving part is such that one of the ends of the magnet coincides with the end of the front flange of the refrigerator cabinet which the gasket contacts.

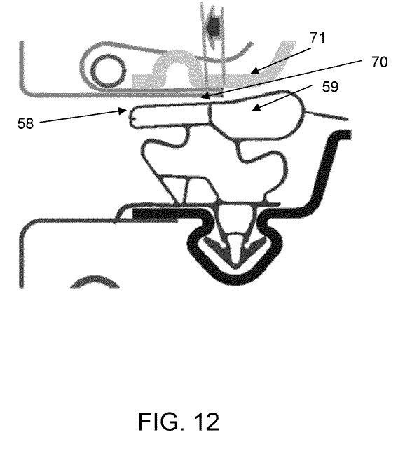

As illustrated in FIG. 12, in the preferred embodiment of the present invention, the position of the magnet receiving part 58 is such that the end of the magnet does not coincide with the end of the central flange 70, but is offset towards the outside of the cabinet. In a preferred embodiment, this displacement is of approximately 2 mm, however, a variation of approximately 30% in this dimension still allows achieving the advantages brought up by the proposed geometry.

This characteristic gives the benefit of robustness to the static drop of the door, making the sealing more efficient. Therefore, it must be noted that the setting of the end part 59, protruded towards the refrigerator cabinet (outward the body gasket), helps assuring a proper sealing, since it overlaps the end part of the metallic flange which does not receive the magnet, contacting a plastic flange 71 of the refrigerator.

Therefore, it must be noted that the dimensions of the end part 59 may vary according to the refrigerator dimensions, since they must be measured in a way to assure this part 59 contacts the plastic flange 71, providing sealing.

The geometry proposed for the sealing bag 50, together with the construction proposed for the attachment part 40, allows the gasket of the present invention to present a higher efficiency than the gaskets known in the art, especially concerning the ability of resistance to compression, traction and torsion forces.

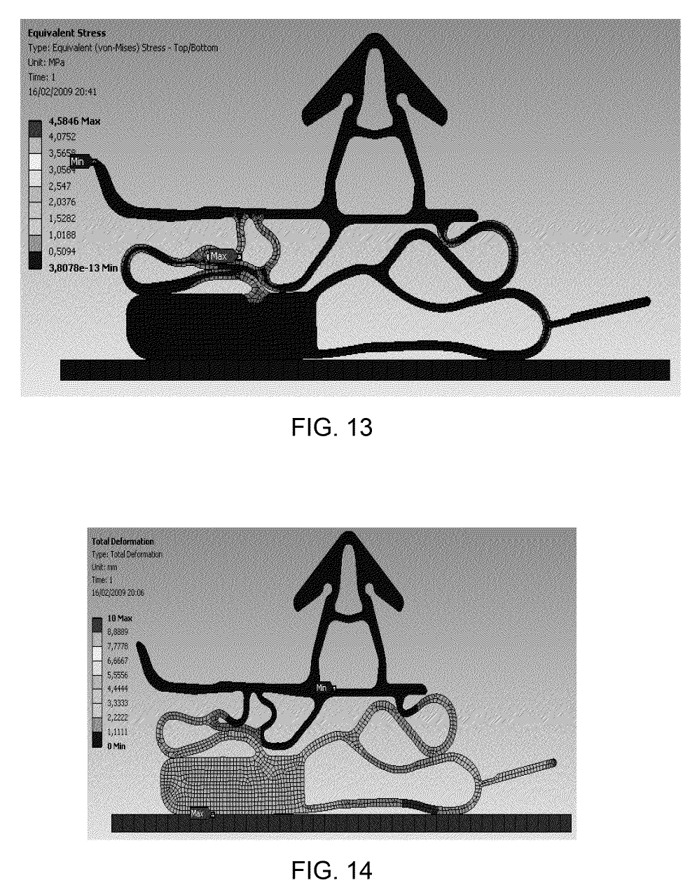

Therefore, FIGS. 13 to 16 illustrate the behavior of the gasket of the present invention upon compression, traction and torsion forces. It must be noted that a comparison between FIGS. 13 to 16 and FIGS. 2 to 5 (which are related to the prior art gasket), indicates that the gasket of the present invention has a compression resistance approximately 195% higher than the prior art gasket, a distress resulting from traction approximately 0.6% shortest than the of the prior art gasket, and approximately 2% less torsion than prior art gasket.

In addition, the solution proposed for the gasket of the present invention allows an improvement in the properties of resistance to compression, traction and torsion forces, without, however, implicating in a mass increase of the gasket. On the contrary, the gasket of the present invention presents an amount of optimized mass, with thin walls properly reinforced in order to provide resistance. A comparison to the prior art gasket shown in FIGS. 1 to 5, shows that the gasket of the present invention has an average of 11% less mass than the prior art gasket. Naturally, this advantage leads to a remarkable reduction in the gasket cost.

It must be noted that the characteristics of the geometry proposed for the attachment portion 40 and for the sealing bag 50 directly influenced the improvements obtained with the present invention.

Therefore, the decrease in the distress of the gasket upon traction forces is directly related to the form and thickness dimensions of the reinforcement structure 55, to the length of the side walls 54, 55, to the existence and dimensions of part of the bent wall 59a of the end part 59, and to the reinforcement in the supporting point 56. Likewise, the resistance to the forces of compression is directly related to the form and thickness dimensions of the reinforcement structure 55, to the dimension of the base of the “half arrow” of the wall 54 and the dimensions of the magnet receiving part 58. The improvement in the tension resistance, has as main features the dimension of the base of the “half arrow” of the wall 54, the thickness of the parts of wall 54b, 54c, 54d and 54e and the dimensions of the magnet receiving part 58.

In the preferred embodiment of the present invention illustrated in FIGS. 6 to 14, the total length of the gasket in a resting condition is approximately 25.2 mm, being the total length of the sealing bag of approximately 16.5 mm (measured from the plane of the base wall 51 to the plane which grazes the part of the end portion 59 which is more transversely away from the plane of the base wall 59).

Still in the preferred embodiment, the magnet receiving part 58 has a substantially rectangular form, with the longest sides having approximately 10mm and the shortest sides having approximately 2.5 mm.

It must be noted, however, that these dimensions may vary within the geometry proposed by the present solution, and a variation of approximately 10% in this dimension still allows achieving the advantages brought up by the proposed geometry.

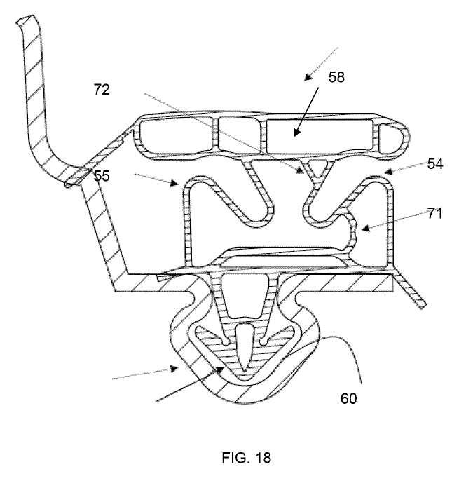

FIGS. 17 and 18 show an alternative embodiment of the sealing system of the present invention. In this embodiment, the attachment part 40 presents a construction resembling the one of the embodiments illustrated in FIGS. 6 to 14, but wherein the bag has a different construction.

Thus, in this alternative embodiment, the bag 50 comprises a base part 51 for the attachment part 40, a pillar-shaped body part 52, and a contacting part 53 which contacts the refrigerator cabinet when the part is closed.

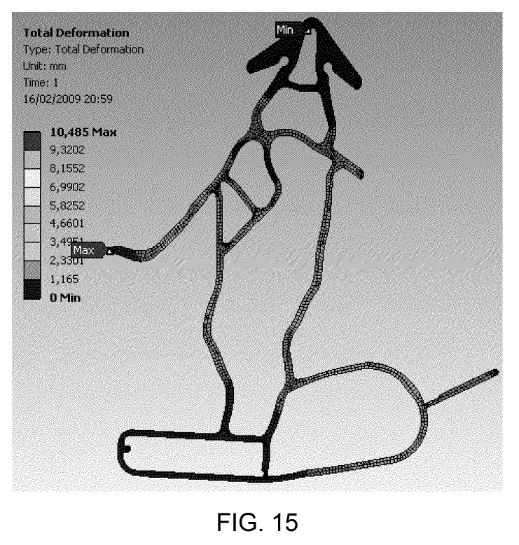

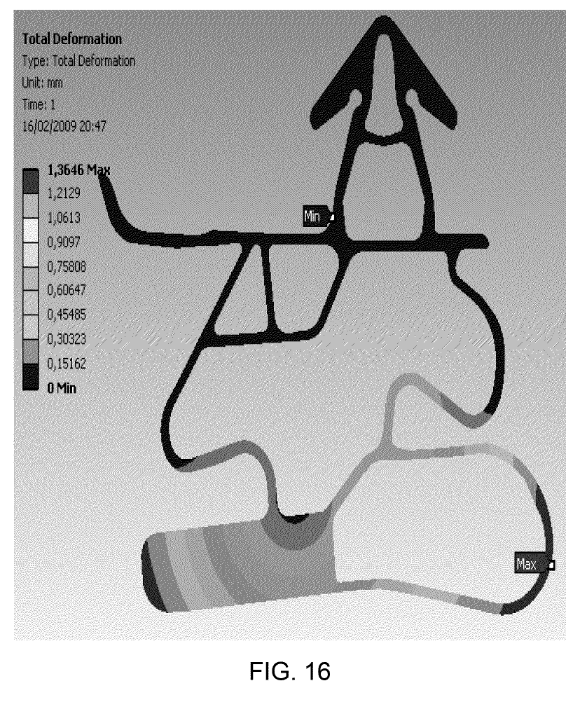

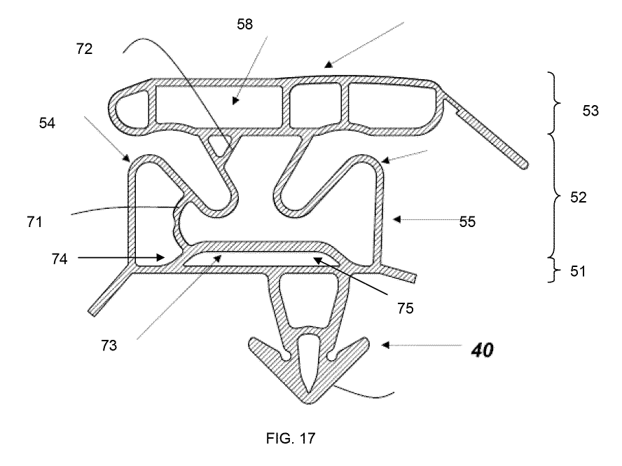

The base part 51 basically comprises a base wall 51 which closes the “W” formed by the body portion 42 of the attachment part 40 and extends lengthwise the body part 52 of the bag 50. In the embodiment illustrated in FIGS. 15 and 16, the base wall 51 remains substantially parallel to the refrigerator door.

The body part 52 of the bag 50 comprises two side walls 54, 55. When in rest setting (in which the gasket is not under compression and traction forces), each of the walls 54, 55 comprise an S shape, the supporting body part 20 further comprising two supporting elements 71, 72 able to provide traction resistance to the bag 50, and a reinforcement 73 responsible for stabilizing the gasket during its work, that is, during the opening and closing movement of the door, therefore avoiding the torsion of the bag 50.

The reinforcement 73 is set up as a parallel wall to the base wall 51, being joined to the latter by two bent walls 74, 75.

The supporting element 71 comprises a curved wall joined to the reinforcement 73 and to the wall 54 of the body part of the bag, and the supporting element 72 comprises a bent wall joined to the wall 54 of the body part of the bag to the base part of the bag.

Therefore, it must be noted that the bag part of the second embodiment of the gasket of the present invention presents a contacting part 53 shaped differently from that of the first embodiment, being the magnet receiving portion 58 disposed adjacently to the hollow structures which were a substantially parallel contacting part to the base wall 51.

It must be understood that the description provided based on the above figures relates only to two of the possible embodiments for the device of the present invention, and the real scope of the object of the invention is defined in the appended claims.

1. A sealing gasket for refrigerator door comprising a attachment part joined to the sealing bag, wherein the attachment part comprises an end portion having a substantially triangular profile and a body portion having a W-shaped cross section with bulged walls, being the end portion formed by two flaps, each of the flaps forming an angle with each of the bulged walls.

2. The sealing gasket, according to claim 1, wherein the joint between each of the flaps and each of the bulged walls presents a tension relief opening.

3. The sealing gasket, according to claim 1, wherein the sealing bag comprises a base part for the attachment part, a pillar-shaped body part, and a contacting part which contacts at least part of a refrigerator cabinet.

4. The sealing gasket, according to claim 3, wherein the base part comprises a base wall extending substantially parallel to the refrigerator door.

5. The sealing gasket, according to claim 1, wherein the pillar-shaped body part comprises two side walls and a reinforcement structure.

6. The sealing gasket, according to claim 5, wherein the reinforcement structure comprises a parallelogramal lattice structure, with one of the longest sides defined by part of the base wall and one of the shortest sides defined by part of the wall.

7. The sealing gasket, according to claim 6, wherein the second shortest side of the parallelogram starts in a supporting part of the base wall, the supporting part concurrent to the part of the base wall which is joined with one of the bulged walls of the body part of the attachment portion.

8. The sealing gasket, according to claim 3, wherein the contacting part comprises a magnet receiving part and an end portion.

9. The sealing gasket, according to claim 8, wherein the magnet receiving part is offset relating to the end of the outer flange of the refrigerator cabinet, towards the outside of the cabinet.

10. A sealing system comprising:
a sealing gasket as defined in claim 1, and
a receiving channel comprising a triangular part defined by two side walls which are located in a vertex end, and an opening part which receives a attachment part of the gasket.

11. The sealing gasket, according to claim 2, wherein the sealing bag comprises a base part for the attachment part, a pillar-shaped body part, and a contacting part which contacts at least part of a refrigerator cabinet.

12. The sealing gasket, according to claim 2, wherein the pillar-shaped body part comprises two side walls and a reinforcement structure.

13. The sealing gasket, according to claim 4, wherein the contacting part comprises a magnet receiving part and an end portion.

14. The sealing gasket, according to claim 5, wherein the contacting part comprises a magnet receiving part and an end portion.

15. The sealing gasket, according to claim 6, wherein the contacting part comprises a magnet receiving part and an end portion.

16. The sealing gasket, according to claim 7, wherein the contacting part comprises a magnet receiving part and an end portion.

17. A sealing system comprising:
a sealing gasket as defined in claim 2, and
a receiving channel comprising a triangular part defined by two side walls which are located in a vertex end, and an opening part which receives a attachment part of the gasket.

18. A sealing system comprising:
a sealing gasket as defined in claim 3, and
a receiving channel comprising a triangular part defined by two side walls which are located in a vertex end, and an opening part which receives a attachment part of the gasket.

19. A sealing system comprising:
a sealing gasket as defined in claim 4, and
a receiving channel comprising a triangular part defined by two side walls which are located in a vertex end, and an opening part which receives a attachment part of the gasket.

20. A sealing system comprising:
a sealing gasket as defined in claim 5, and
a receiving channel comprising a triangular part defined by two side walls which are located in a vertex end, and an opening part which receives a attachment part of the gasket.
